(19) United States
(12) Patent Application Publication
(10) Pub. No.: US 2014/0022165 A1
(43) Pub. Date: Jan. 23, 2014

(54) TOUCHLESS TEXT AND GRAPHIC INTERFACE

(71) Applicant: Igor Melamed, Ottawa (CA)

(72) Inventor: Igor Melamed, Ottawa (CA)

(21) Appl. No.: 14/110,195

(22) PCT Filed: Apr. 10, 2012
(86) PCT No.: PCT/CA2012/000344

§ 371 Date: Oct. 7, 2013

Related U.S. Application Data
(60) Provisional application No. 61/474,125, filed on Apr. 11, 2011.

(51) Int. Cl. G06F 3/01

(52) U.S. Cl. CPC G06F 3/014
USPC 345/156

(57) ABSTRACT

The present invention relates to a method for a user to type text on a computer screen using wireless actuators attached to the user's fingers. The image of a virtual keyboard and the user's virtual fingers appears on the computer screen. As the user moves his fingers the virtual fingers on screen moves accordingly aiding the user to type. The actuators transmit symbol information to the computer indicative of a key virtually struck on the virtual keyboard by the user's fingers. Text appears on screen. Virtual typing emulates typing on a physical keyboard. In other embodiments the actuators are coupled to other parts of the body for virtual typing.

### FIELD OF THE INVENTION

The invention relates to user interfaces and more particularly to a user interface device and method for emulating a keyboard.

### BACKGROUND OF THE INVENTION

In the past, a keyboard was the main peripheral used to provide human input into a computer system. Today more advanced peripherals are available to the user. The demand for simple methods for inputting data into a computer system and the increased complexity of the computer system itself has driven advancements in human-machine interface technology. Some examples include wireless keyboards, wireless mouse, voice, and touch screen mechanisms.

Another common human-machine interface in use today is the touch screen. These are common features of tablets and mobile smart phones. Unfortunately, a touch screen is ill suited to act as a keyboard because the tactile feedback does not indicate the boundary between keyboard keys and the keys are spaced very closely. As such, typing for most users requires looking at the screen to see what is typed. A common approach to easing the user's discomfort is automated spell check, which, in and of itself, is problematic.

There are many situations where typing would be highly beneficial but where keyboards are not available or easily implemented. Unfortunately, because of the aforementioned drawbacks, smart phones and tablets are ill suited to fulfill this function.

### SUMMARY OF THE INVENTION

In accordance with the invention there is provided a method comprising providing a plurality of accelerometers; coupling the accelerometers to a plurality of fingers of a user; using the accelerometers to detect relative motion between the user's fingers; providing a signal including first data relating to the relative motion to a first processor, the first processor for determining a unique symbol in response to the motion, the first symbol indicative of a key virtually struck by a keystroke motion of the user's fingers.

In accordance with another embodiment of the invention there is provided a method comprising providing an accelerometer; coupling the accelerometer to a hand of a user; using the accelerometer to detect motion of the hand; using a first processor and based on the motion, determining a symbol entry, wherein the symbol is a unique output in response to the motion; and providing the symbol to a computer.

In accordance with another embodiment of the invention there is provided a method comprising providing an accelerometer; coupling the accelerometer to a body part of a user; using the accelerometer to detect motion of the body part; based on the motion, determining a symbol entry, wherein the symbol is a unique output value in response to the motion; and providing the symbol to a computer.

### BRIEF DESCRIPTION OF THE DRAWINGS

FIG. 1 illustrates a user interfacing with a PC via transducers wherein the transducers are coupled to the user's fingers.

FIG. 2 illustrates a diagram of transducers.

FIG. 3 illustrates the flow diagram of a user using transducers to interface with a smart phone wherein the transducers are coupled to the user's fingers.

FIG. 4 illustrates the flow diagram of the user training to use transducers wherein the transducers are coupled to the user's fingers.

FIG. 5. illustrates a user interfacing with a computer comprising a PDA wherein the transducers are coupled to the user's fingers.

FIG. 6 illustrates the flow diagram of a user using transducers to interface with a PDA wherein the transducers are coupled to the user's fingers.

FIG. 7 illustrates an Application Process Interface (API) device.

FIG. 8 illustrates a user interfacing with a computer in the form of a PC wherein the transducers are coupled to the user's knuckles.

FIG. 9 illustrates a diagram of a transducer comprising a coupling to couple the transducer to a knuckle.

FIG. 10 illustrates the flow diagram of a user using transducers to interface with a smart phone wherein the transducers are coupled to the user's knuckles.

FIG. 11 illustrates the flow diagram of training a user to use transducers wherein the transducers are coupled to the user's knuckles.

FIG. 12 illustrates a user interfacing with a computer comprising a PDA wherein the transducers are coupled to the user's knuckles.

FIG. 13 illustrates the flow diagram of a user using transducers to interface with a PDA wherein the transducers are coupled to the user's knuckles.

FIG. 14 illustrates an Application Process Interface (API) device.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

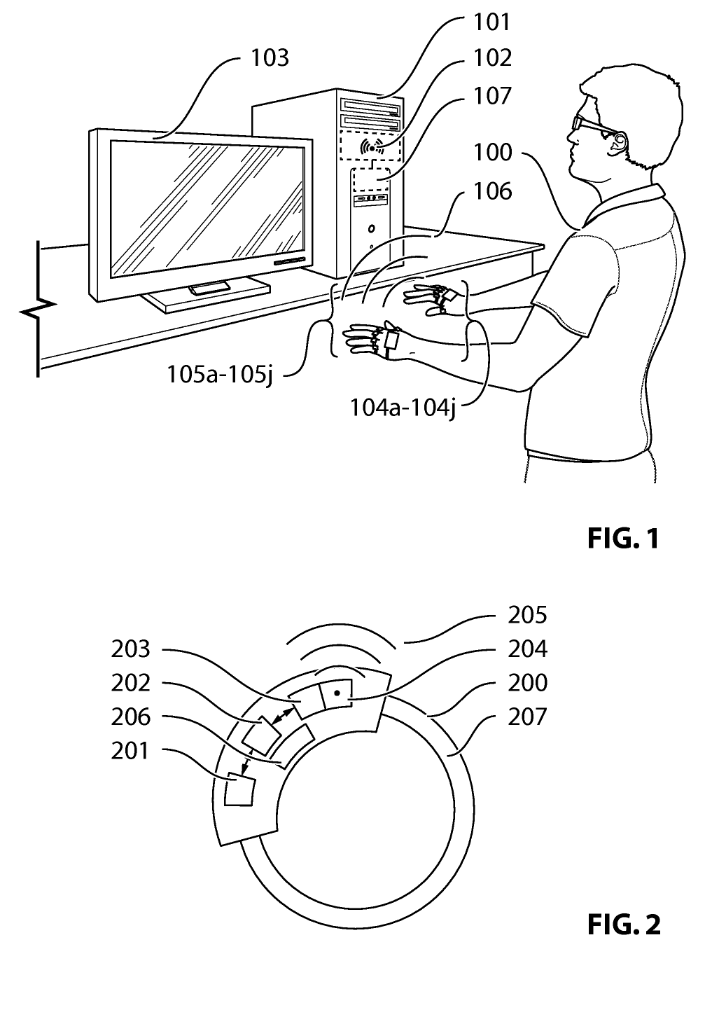

FIG. 1 illustrates a user 100 interfacing with a computer in the form of a PC 101. The PC 101 comprises communication circuitry the form of RF communication circuitry 102 for receiving RF signals 106, a monitor 103 for displaying information, and a processor 107 for executing software. Ten transducers 104a-104j, comprising inertial sensors, for example accelerometers, for detecting relative motion between fingers, are coupled to each of the user's fingers 105a-105j. Each transducer 104a-104j comprises RF communication circuitry for transmitting RF signals 106 to the PC 101. The RF signals are indicative of the motion of the fingers 105a-105j and comprise symbol information corresponding to a character on a known keyboard, the motion in the form of relative motion between the fingers 105a-105j. Optionally, the motion is other than relative motion between fingers. For example, the user 100 types a document in word processing software, for example Microsoft Word™, executing on the PC 101. Due to a missing portion of a finger the user has difficulty typing on a known keyboard. Attaching the transducers to his fingers he types characters by moving his fingers to positions that correspond to the positions of the characters on a known keyboard. For example, the user has become familiar with the finger positions that correspond to characters of the keyboard. Alternatively, the system has learned the user's typing movements and mapped them onto keystrokes. Further alternatively, the system provides a fixed spatial relation between the user's fingers and keys and these fixed spatial relationships are used to determine which key is being selected. For keystroke determination, either a finger that is closest to the motion limit or a specific motion such as a poke can be used. Of course, more complete understanding will flow from a review of the specific embodiments described hereinbelow.

Each transducer 104a-104j transmits information signals in the form of RF signals 106 indicative of the relative motion between fingers 105a-105j to the RF communication circuitry 102 of the PC 101. The PC 101 comprising a processor 107 that executes software for processing the received RF signals 106 determines symbol entries relating to virtual or real keys of the known keyboard that have been “actuated.” Of course, one of skill in the art will appreciate that no real key need be actuated as a symbol entry is based on the RF signals 106. Text appears on the monitor 103 as if the user input the data by typing on the known keyboard. The user interface is transparent to the Microsoft Word™ software and the user 100 accesses all menus and features of the word processing software as if he were using the known keyboard and the lost digit is no longer an impediment to the user. Alternatively the inertial sensors comprise gyroscopes for detecting the relative motion between the fingers. Alternatively the communication circuitry comprises wireless electromagnetic circuitry. Further alternatively the communication circuitry comprises fiber-less optoelectric circuitry.

FIG. 2 illustrates a diagram of transducer 200 comprising a coupling 207 to couple the transducer 200 to a finger. The transducer 200 comprises an inertial sensor in the form of a gyroscope 201 and a processor 202 to which the gyroscope 201 is coupled. When the finger moves the gyroscope 201 detects the motion and transmits information indicative of the motion to the processor 202. As in the embodiment illustrated in FIG. 1 the finger movement corresponds to actuating a character on the virtual or real keyboard. The processor 202 processes the information and transmits data indicative of the motion to a communication circuit in the form a RF communication circuit 203 to which it is coupled. The RF communication circuit 203 comprises an RF antenna for propagating the RF signal 205 to RF communication circuitry of the computer 102. The RF signals 205 are transmitted to the PC 101 wherein it is received by the RF communication circuitry 102 and is processed by software, for interfacing with transducers, executed on the processor 107. The transducer 200 also comprises a rechargeable battery 206, freeing the user from cumbersome power chords. Optionally the inertial sensors comprise accelerometers for detecting the relative motion between the fingers. Alternatively the communication circuitry comprises wireless electromagnetic circuitry. Further alternatively the communication circuitry comprises fiber-less optoelectric circuitry.

The computer to which the transducers communicate comprise, but are not limited to, mobile devices, smart phones, PDAs (Personal Digital Assistant), tablets, and A™ machines. One can appreciate the advantage of interfacing, via transducers, with a computer that does not comprise a keyboard or keypad. For example, the touch screen of a smart phone is small, the letter icons are close together, and it does not provide tactile feedback to indicate the boundary between keyboard keys. Due to the aforementioned difficulties the user resorts to typing with one finger or two thumbs, increasing the time it would take to type the email, and the number of typos, in comparison to using a known keyboard. These problems are alleviated when the user uses transducers to type. He is not restricted to a typing on a small surface and moves all fingers quickly to type the email. Also, the user is free from watching the screen intently to monitor and correct typos. This freedom allows him to go for a walk or watch his children play while typing at the same time.

According to an embodiment of the invention, the computer is a video gaming system comprising a web browser. The user interface is other than a keyboard and is the video game controller provided with the system. The user surfs the web and downloads new games to his video game console, using the transducers to type in the browser, instead of the video game controller wherein the user would have to select each character individually. One of skill in the art will appreciate that transducers are beneficial when used for interfacing with computers, which comprise small keyboards, key pads, touch screens, and those with interfaces other than keyboards, key pads, and touch screens.

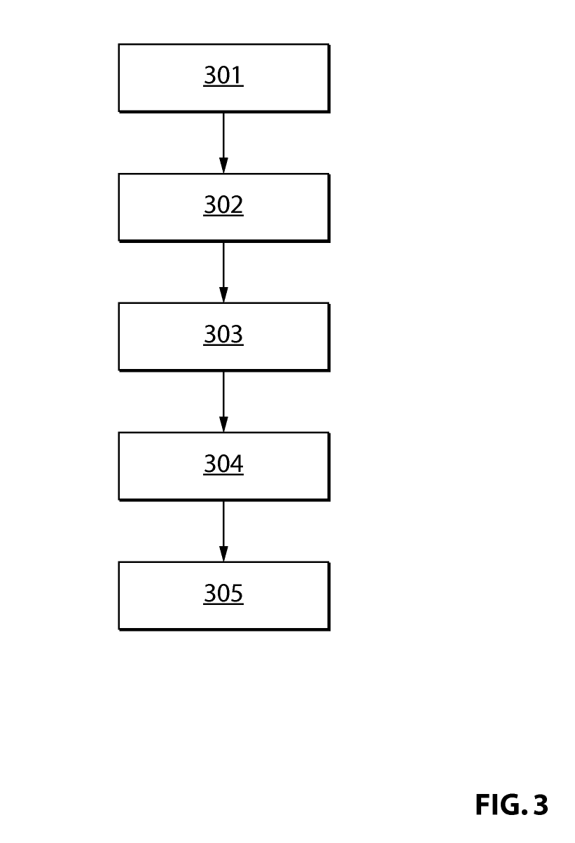

FIG. 3 illustrates a flow diagram of a user using transducers to interface with a smart phone according to an embodiment of the invention. The user installs software on the smart phone for enabling the smart phone to interface with the transducers 301. The user attaches the transducers to his fingers and “pairs” the smart phone with the transducers 302 via wireless electromagnetic or optoelectronic communication signals. When the devices are “paired” an indication appears on the screen of the smart phone indicating that they are communicating via wireless electromagnetic or optoelectronic signals 303. The user opens an application on the smart phone, for example text messaging, and begins typing 304. Information signals, in the form of wireless electromagnetic or optoelectronic communication signals, are transmitted from the transducers to the smart phone wherein the software executing on the smart phone processes the symbol entries and text appears on the screen 305.

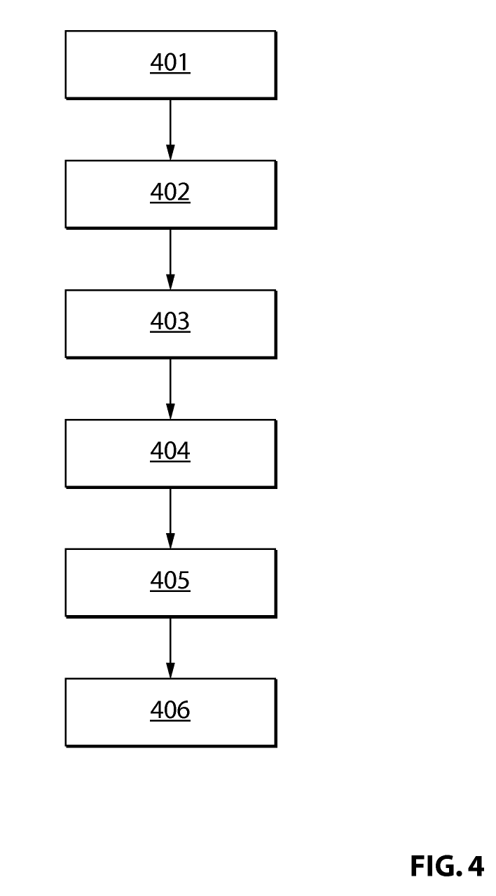

FIG. 4 illustrates the flow diagram of training a user to use transducers. Software executed on a PC displays an image of a keyboard and the semitransparent image of at least a user's hand, 400. The image of the user's hand changes as the position of the user's hand changes, 401. This video feedback enables the user to visualize the position of his hands and fingers with respect the virtual keyboard. As the user moves his fingers he studies the image of his fingers actuating the keys on the virtual keyboard on screen, 402. If he misses the virtual keys he intended to strike, or strikes the wrong keys, he modifies the position of his fingers to strike the intended virtual keys 403. To aid the user, the character he actuates on the virtual keyboard appears on screen 404. Optionally the user zooms in on the image of his hands to provide a detailed view of his virtual fingers and virtual keyboard 405. The user continues this learning process until he has mastered manipulating the transducers such that he actuates the virtual keys as intended 406.

According to an embodiment of the invention, the user customizes the system to accommodate the user's preferred typing style. The system comprises transducers, a computer, and software executing on the computer. In contrast to the embodiment described above the user chooses the position of the keys on the virtual keyboard instead of the system providing a virtual keyboard to the user. The user moves his fingers repeatedly to actuate a specific key on the virtual keyboard until the system has learned that that movement represents the user striking a specific key on the virtual keyboard. Optionally the image of the user's fingers actuating the keys on the keyboard is on screen for the duration of the use of the transducers by the user. Further optionally the image of the user actuating the keys on the keyboard is on screen and disappears when the user is typing quickly and reappears when the user types slowly or pauses typing.

For example, a paragraph is provided to the user to type. The user types the paragraph and during typing of the paragraph, the system learns the user's behaviors associated with each keystroke. For example, a neural network is used to determine what keystroke is being initiated through a standard training process. For example, if the user repeatedly keeps keys depressed for a longer time than necessary, multiple characters of the same letter will appear on screen and the user deletes the extra characters not intended. The neural network learns the average length of time the user depresses a key to type a single character and multiple characters of the same letter no longer appear on screen as it previously had before. Alternatively, an expert system or analytic system is used to map the user's behavior in typing known text to a prediction or determination of what a user's specific actions relate to—what keystroke is intended. Once training is completed, the device is ready for general use. Optionally, each time the user starts using the device, a training exercise is provided in order to maintain—tune—the training or to accommodate movement in the transducers from one use to another. Further optionally, the user modifies parameters of the transducers to customize the sensitivity of the transducers. For example, if the response time is increased the rate at which the characters appear on the screen increases and if it is reduced the characters appear more slowly. Further, if the range of motion is increased the distance between the virtual keys on the virtual keyboard increases, which is ideal for users with large hands. If the range of motion is decreased the distance between the virtual keys on the virtual keyboard decreases which is suitable for users with small hands.

According to an embodiment of the invention an image of the virtual keyboard and the user's hands remain on the computer's screen for the duration of the user typing via the transducers. This enables the user to place his hands in any position, observe the position of his fingers with respect to the virtual keyboard and successfully type. For example, the user sits with his arms folded across his body wherein each hand is disposed on top of the opposite bicep. Observing the images on the computer screen the user moves his fingers and types on his biceps, adjusting the motion as required to actuate the virtual keys as desired. One can visualize other surfaces on which the user types. For example, body parts, desks, walls, dashboards, flat surfaces, soft surfaces, uneven surfaces, as well no surface at all, for example typing in the air. Optionally, the user conceals his hands while typing for example in gloves or his pocket without impeding the functionality of the transducers.

Optionally the user configures the virtual keyboard to type in specific languages. For example, a user uses word processing software in a non-Latin based language such as Chinese, however the keyboard he uses show keys with Latin based characters only. Typically the user memorizes the Latin based character that represents the Chinese character he wishes to type. This process is tedious for the user and prone to error. Configuring the virtual keyboard to represent Chinese characters on each key the user no longer has to map the Latin based characters to Chinese symbols. Further optionally the user configures the virtual keyboard to be a numeric keypad.

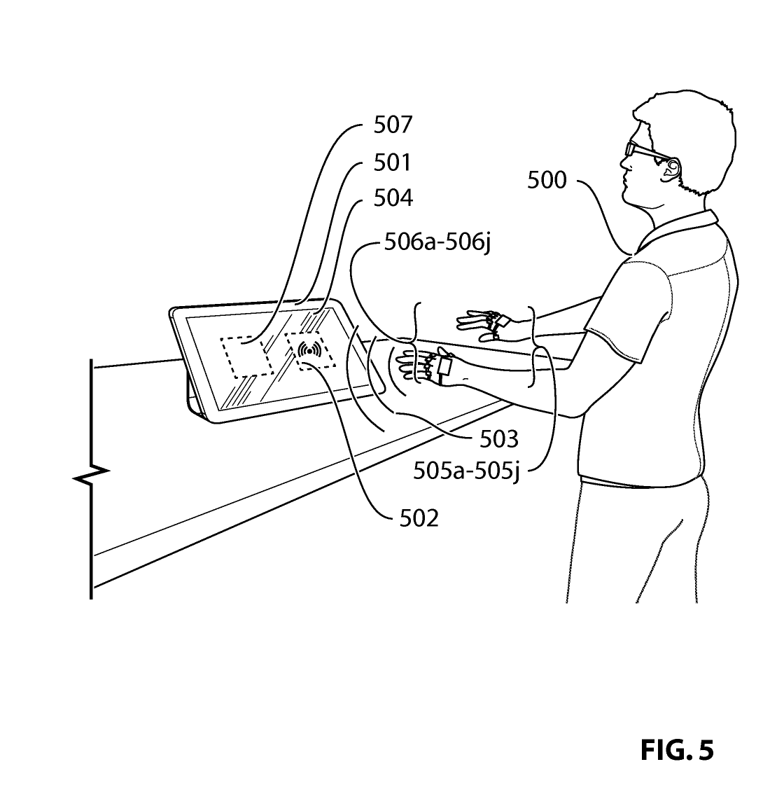

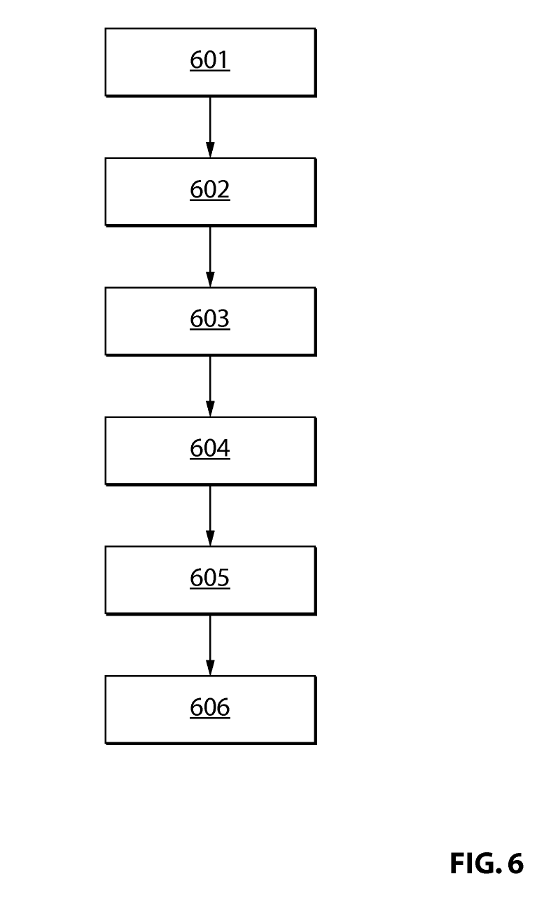

FIG. 5. illustrates a user 500 interfacing with a computer comprising a PDA 501. The PDA 501 comprises a communication circuit in the form of a Bluetooth™ communication circuit 502 for receiving Bluetooth™ signals 503, a user interface in the form of a touch screen 504, a processor 507 for executing software. The user couples 10 transducers 505a-505j to ten fingers 506a-506j. Each transducer 505a-505j comprises a communication circuit in the form of a Bluetooth™ communication circuit for transmitting Bluetooth™ signals 503, and inertial sensor in the form of a gyroscope. As the user types the Bluetooth™ communication circuit of the transducer transmits information indicative of the motion to the PDA 501. The Bluetooth™ signals 503 are transmitted to the PDA 501 wherein it is received by the Bluetooth™ communication circuitry 502 and is processed by software executed on the PDA 501 and appears on the touch screen 504. The transducers 505a-505j also comprise at least a rechargeable battery, freeing the user from cumbersome power chords. Optionally the inertial sensors comprise accelerometers for detecting the relative motion between the fingers. Alternatively the communication circuitry comprises wireless electromagnetic circuitry. Further alternatively the communication circuitry comprises fiber-less optoelectric circuitry.

FIG. 6 illustrates the flow diagram of a user using transducers to interface with a PDA. The user installs software on the PDA to enable the smart phone to interface with the transducers 601. The user attaches the transducers to his fingers and “pairs” the smart phone and the transducers 602. When the devices are “paired” an indication appears on the screen of the PDA indicating that they are communicating via wireless electromagnetic or optoelectronic signals 603. The user opens an application on the smart phone, for example SMS messaging 604 and begins typing 605. Information signals are transmitted from the transducers to the PDA 605. Software executing on the smart phone processes the symbol entries and text appears on the screen 606. Optionally the image of the user's fingers actuating the keys on the keyboard is on screen for the duration of the use of the transducers by the user. Further optionally the image of the user actuating the keys on the keyboard is on screen and disappears when the user is typing quickly and reappears when the user types slowly or pauses typing.

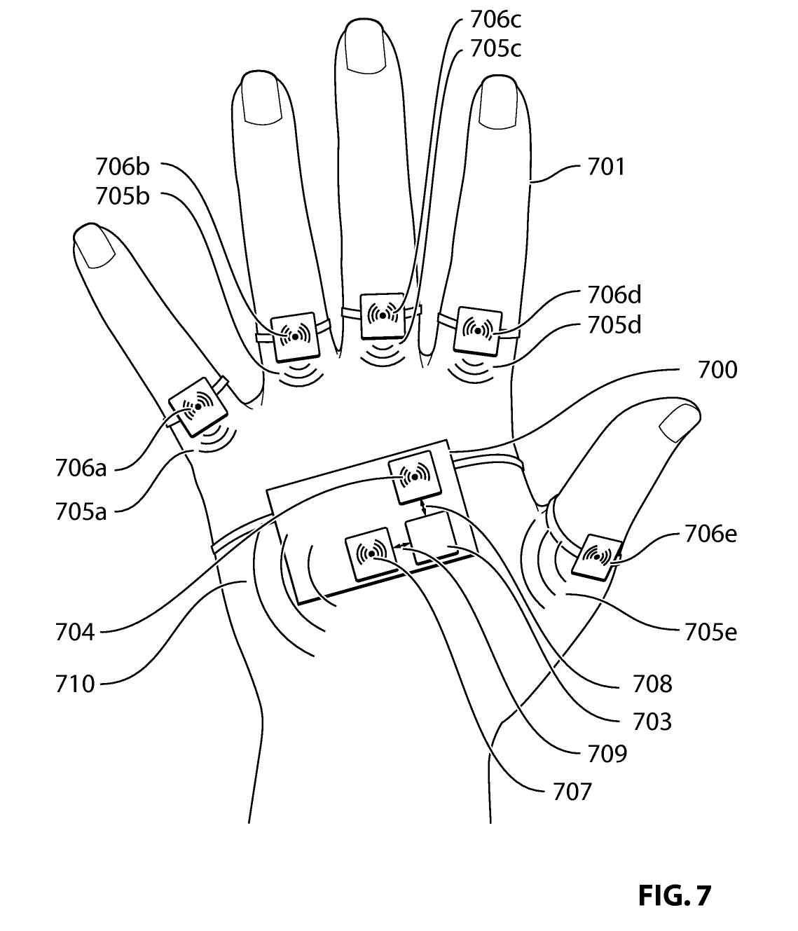

FIG. 7 illustrates an interface device 700 coupled to a user's hand 701, comprising a processor 703 for executing API software and a first wireless communication circuit 704, in the form of an infrared communication circuit, for receiving information signals 705a-705e, in the form of infrared wireless signals, and a second wireless communication circuit 707, in the form of a Bluetooth™ communication circuit 707 for transmitting Bluetooth™ signals to a computer. The transducers 706a-706e is coupled to the user's knuckles. As the user types, the infrared communication circuits of the transducers 706a-706e transmits infrared wireless information signals, representing symbol entries, to the infrared communication circuit 704. The infrared communication circuit 704 transmits first data indicative of the information signals received 705a-705e via data interface 708 to the processor 703. The processor 703 executes API software, processes the first data, and transmits second data indicative of symbol entries via the data interface 709 to the Bluetooth™ wireless communication circuit 707. The API software formats the second data wherein the Bluetooth™ wireless signal 708, transmitted from the Bluetooth™ communication circuit 707, emulates the wireless interface from a known wireless peripheral, for example a wireless Bluetooth™ keyboard. Emulating a known wireless peripheral interface eliminates the need to install transducer-interfacing software on the computer thus increasing transducer compatibility with computers comprising known wireless peripheral communication interfaces. Alternatively the communication circuitry comprises wireless electromagnetic circuitry. Further alternatively the communication circuitry comprises fiber-less optoelectric circuitry. Optionally transducers are coupled to a knuckle or a finger wherein the inertial sensors detect relative motion between the fingers and or the knuckles.

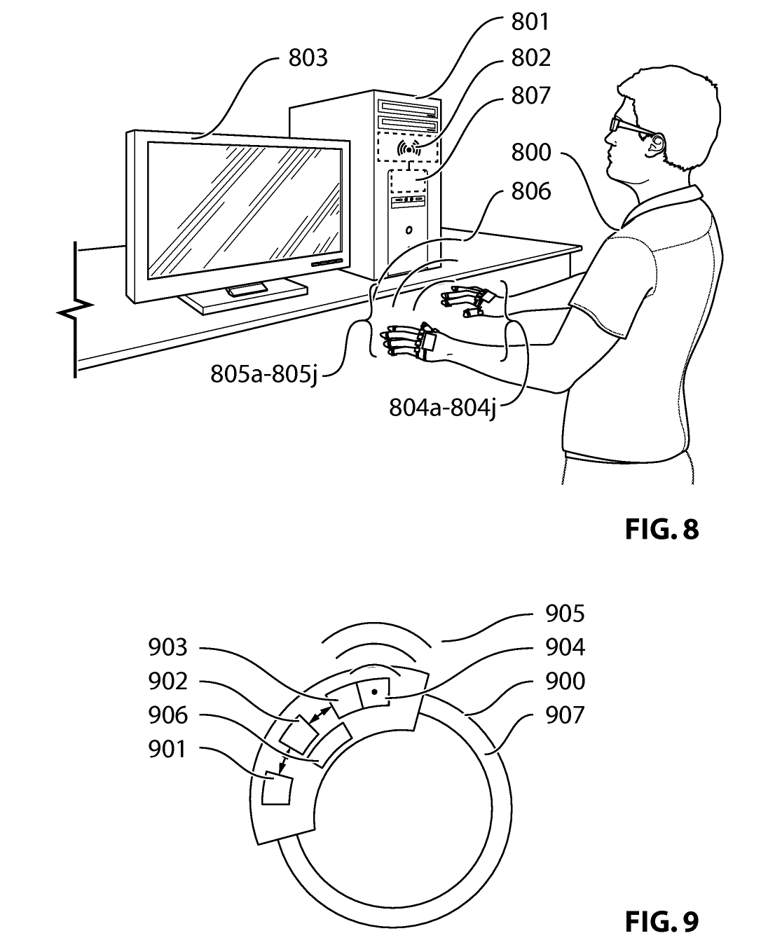

FIG. 8 illustrates a user 800 interfacing with a computer in the form of a PC 801. The PC 801 comprises communication circuitry the form of RF communication circuitry 802 for receiving RF signals 806, a monitor 803 for displaying information, and a processor 807 for executing software. Ten transducers 804a-804j, comprising inertial sensors, for example accelerometers, for detecting relative motion between the knuckles of each of the user's fingers, are coupled to the user's hand near each knuckle of the user's fingers 805a-805j. Alternatively the sensor is placed on the back of the hand other than on the knuckle. Each transducer 804a-804j comprises RF communication circuitry for transmitting RF signals 806 to the PC 801. The RF signals are indicative of the relative motion between the knuckles 805a-805j and comprise symbol information corresponding to a character on a known keyboard. For example, the user 800 types a document using word processing software, for example Microsoft Word™, executing on the PC 801. Due to a missing portion of a finger the user has difficulty typing on a known keyboard. Attaching the transducers to his knuckles he types characters by moving his fingers to positions that correspond to the positions of the characters on a known keyboard. Each transducer 804a-804j transmits information signals in the form of RF signals 806 indicative of the relative motion between knuckles 805a-805j to the RF communication circuitry 802 of the PC 801. The PC 801 comprising a processor 807 that executes software for processing the received RF signals 806 determines symbol entries relating to virtual or real keys of the known keyboard that have been “actuated.” Of course, one of skill in the art will appreciate that no real key need be actuated as a symbol entry is based on the RF signals 806. Text appears on the monitor 803 as if the user input the data by typing on the known keyboard. The user interface is transparent to the Microsoft Word™ software and the user 800 accesses all menus and features of the word processing software as if he were using the known keyboard and the lost digit is no longer an impediment to the user. Alternatively the inertial sensors comprise gyroscopes for detecting the relative motion between the knuckles. Alternatively the communication circuitry comprises wireless electromagnetic circuitry. Further alternatively the communication circuitry comprises fiber-less optoelectric circuitry. Optionally transducers are coupled to a knuckle or a finger wherein the inertial sensors detect relative motion between the fingers and or the knuckles. Further optionally, the inertial sensors are coupled elsewhere on the hand for providing sufficient inertial information for use in keystroke determination. Optionally the image of the user's fingers actuating the keys on the keyboard is on screen for the duration of the use of the transducers by the user. Further optionally the image of the user actuating the keys on the keyboard is on screen and disappears when the user is typing quickly and reappears when the user types slowly or pauses typing.

FIG. 9 illustrates a diagram of a transducer 900 comprising a coupling 907 to couple the transducer 900 to a knuckle. The transducer 900 comprises an inertial sensor in the form of a gyroscope 901 and a processor 902 to which the gyroscope 901 is coupled. When the knuckle moves the gyroscope 901 detects the motion and transmits information indicative of the motion to the processor 902. As in the embodiment illustrated in FIG. 8 the knuckle movement corresponds to actuating a character on the virtual or real keyboard. The processor 902 processes the information and transmits data indicative of the motion to a communication circuit in the form a RF communication circuit 903 to which it is coupled. The RF communication circuit 903 comprises an RF antenna for propagating the RF signal 905 to RF communication circuitry of the computer 102. The RF signals 905 are transmitted to the PC 801 wherein it is received by the RF communication circuitry 802 and is processed by software, for interfacing with transducers, executed on the processor 807. The transducer 900 also comprises a rechargeable battery, freeing the user from cumbersome power chords. Optionally the inertial sensors comprise accelerometers for detecting the relative motion between the fingers. Alternatively the communication circuitry comprises wireless electromagnetic circuitry. Further alternatively the communication circuitry comprises fiber-less optoelectric circuitry. Optionally transducers are coupled to a knuckle or a finger wherein the inertial sensors detect relative motion between the fingers and or the knuckles. Further optionally, the inertial sensors are coupled elsewhere on the hand for providing sufficient inertial information for use in keystroke determination.

The computer to which the transducers communicate comprises, but is not limited to, mobile devices, smart phones, PDAs (Personal Digital Assistant), tablets, and A™ machines. One can appreciate the advantage of interfacing, via transducers, with a computer that does not comprise a keyboard or keypad. For example, the touch screen of a smart phone is small, the letter icons are close together, and it does not provide tactile feedback to indicate the boundary between keyboard keys. Due to the aforementioned difficulties the user resorts to typing with one finger or two thumbs, increasing the time it would take to type the email, and the number of typos, in comparison to using a known keyboard. These problems are alleviated when the user uses transducers to type. He is not restricted to a typing on a small surface and moves all knuckles quickly to type the email. Also, the user is free from watching the screen intently to monitor and correct typos. This freedom allows him to go for a walk or watch his children play while typing at the same time.

According to an embodiment of the invention, the computer is a video gaming system comprising a web browser. The user interface is other than a keyboard and is the video game controller provided with the system. The user surfs the web and downloads new games to his video game console, using the transducers to type in the browser, instead of the video game controller wherein the user would have to select each character individually. One of skill in the art will appreciate that transducers are beneficial when used for interfacing with computers comprising small keyboards, key pads, touch screens, and those with interfaces other than keyboards, key pads, and touch screens.

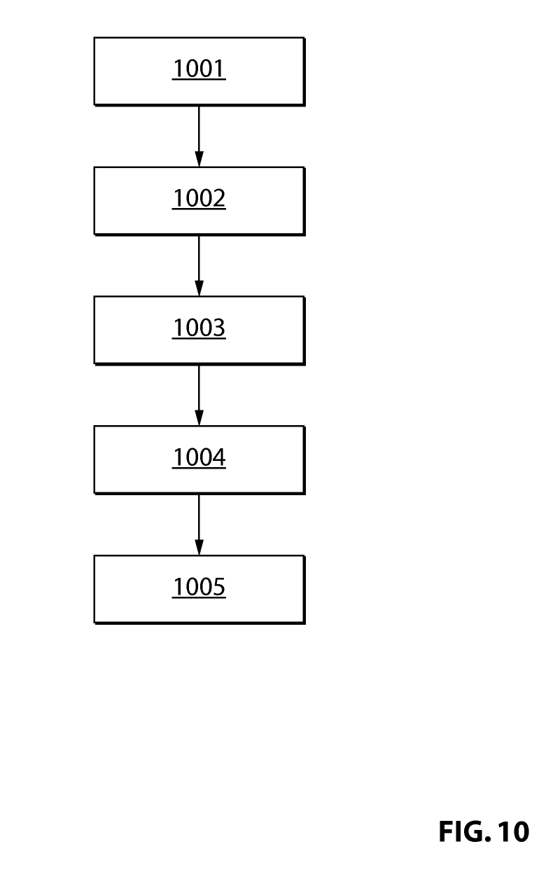

FIG. 10 illustrates a flow diagram of a user using transducers to interface with a smart phone in accordance with an embodiment of the invention. The user installs software on the smart phone for enabling the smart phone to interface with the transducers 1001. The user attaches the transducers to his knuckles and “pairs” the smart phone with the transducers 1002 via wireless electromagnetic or optoelectronic communication signals. When the devices are “paired” an indication appears on the screen of the smart phone indicating that they are communicating via wireless electromagnetic or optoelectronic signals 1003. The user opens an application on the smart phone, for example text messaging, and begins typing 1004. Information signals, in the form of wireless electromagnetic or optoelectronic communication signals, are transmitted from the transducers to the smart phone wherein the software executing on the smart phone processes the symbol entries and text appears on the screen 1005.

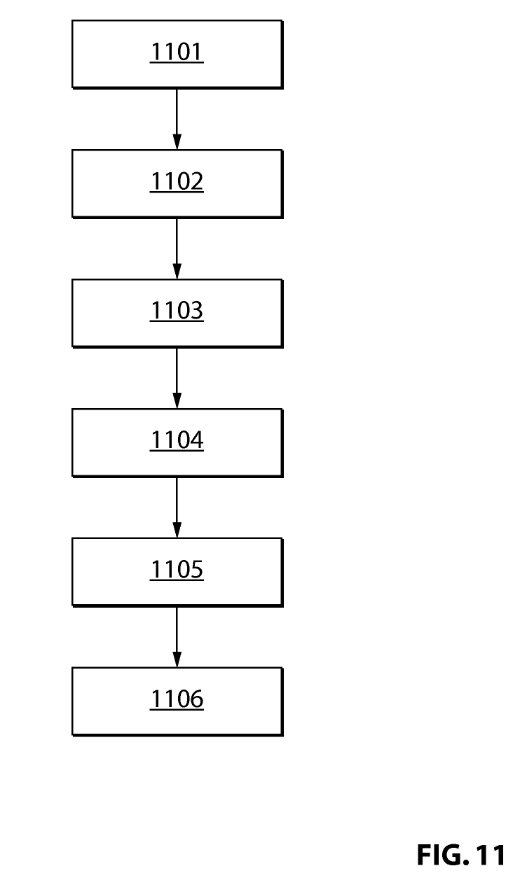

FIG. 11 illustrates the flow diagram of training a user to use transducers. Software executed on a PC displays an image of a keyboard and the semitransparent image of at least a user's hand, 1100. The image of the user's hand changes as the position of the user's hand changes, 1101. This video feedback enables the user to visualize the position of his hands with respect the virtual keyboard. As the user moves his knuckles he studies the image of his fingers actuating the keys on the virtual keyboard on screen, 1102. If he misses the virtual keys he intended to strike, or strikes the wrong keys, he modifies the position of his knuckles to strike the intended virtual keys 1103. To aid the user, the character he actuates on the virtual keyboard appears on screen 1104. Optionally the user zooms in on the image of his hands to provide a detailed view of his virtual fingers and virtual keyboard 1105. The user continues this learning process until he has mastered manipulating the transducers such that he actuates the virtual keys as intended 1106.

According to an embodiment of the invention, the user customizes the system to accommodate the user's preferred typing style. The system comprises transducers, a computer, and software executing on the computer. In contrast to the embodiment described above the user chooses the position of the keys on the virtual keyboard instead of the system providing a virtual keyboard to the user. Similar to configuring a voice controlled system wherein the user speaks a word repeatedly until the system understands the word spoken, the user moves his knuckles repeatedly to actuate a specific key on the virtual keyboard until the system has learned that that movement represents the user striking a specific key on the virtual keyboard.

For example, a paragraph is provided to the user to type. The user types the paragraph and during typing of the paragraph, the system learns the user's behaviors associated with each keystroke. For example, a neural network is used to determine what keystroke is being initiated through a standard training process. Alternatively, an expert system or analytic system is used to map the user's behavior in typing known text to a prediction or determination of what a user's specific actions relate to—what keystroke is intended. Once training is completed, the device is ready for general use. Optionally, each time the user starts using the device, a training exercise is provided in order to maintain—tune—the training or to accommodate movement in the transducers from one use to another.

According to an embodiment of the invention the image of the virtual keyboard and the user's hands remain on the computer's screen for the duration of the user typing via the transducers. This enables the user to place his hands in any position, observe the position of his fingers with respect to the virtual keyboard and successfully type. For example, the user sits with his arms folded across his body wherein each hand is disposed on top of the opposite bicep. Observing the images on the computer screen the user moves his knuckles and types on his biceps, adjusting the motion as required to actuate the virtual keys as desired. One can easily visualize other surfaces on which the user types. For example, body parts, desks, walls, dashboards, flat surfaces, soft surfaces, uneven surfaces, as well no surface at all, for example typing in the air.

Optionally the user configures the virtual keyboard to type in specific languages. For example, a user uses word processing software in a non-Latin based language such as Chinese, however the keyboard he uses show keys with Latin based characters only. Typically the user memorizes the Latin based character that represents the Chinese character he wishes to type. This process is tedious for the user and prone to error. Configuring the virtual keyboard to represent Chinese characters on each key the user no longer has to map the Latin based characters to Chinese symbols. Further optionally the user configures the virtual keyboard to be a numeric keypad.

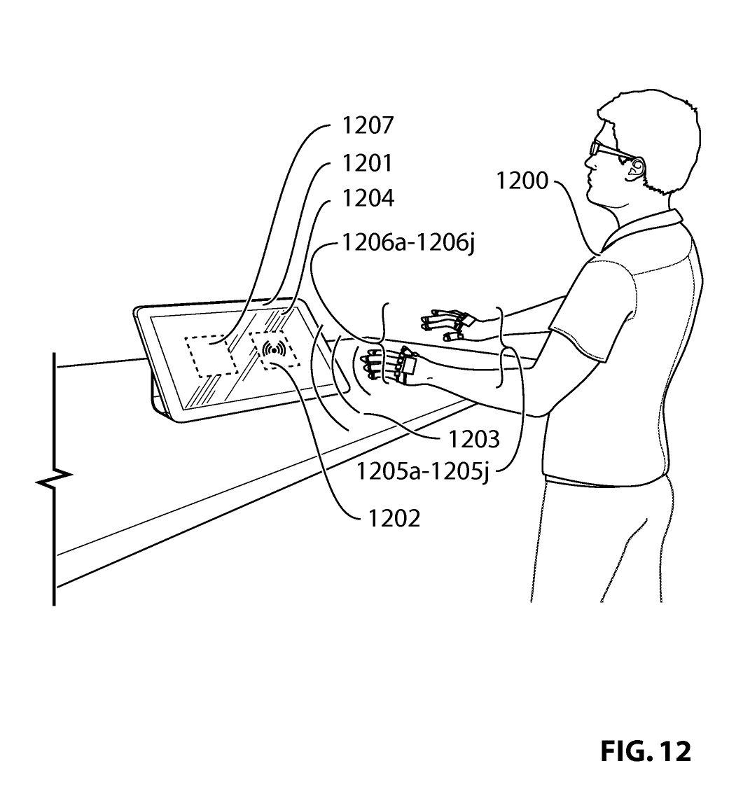

FIG. 12. illustrates a user 1200 interfacing with a computer comprising a PDA 1201. The PDA 1201 comprises a communication circuit in the form of a Bluetooth™ communication circuit 1202 for receiving Bluetooth™ signals 1203, a user interface in the form of a touch screen 1204, a processor 1207 for executing software. The user couples 10 transducers 1205a-1205j to ten knuckles 1206a-1206j. Each transducer 1205a-1205j comprises a communication circuit in the form of a Bluetooth™ communication circuit for transmitting Bluetooth™ signals 1203, and inertial sensor in the form of a gyroscope. As the user types the Bluetooth™ communication circuit of the transducer transmits information indicative of the motion to the PDA 1201. The Bluetooth™ signals 1203 are transmitted to the PDA 1201 wherein it is received by the Bluetooth™ communication circuitry 1202 and is processed by software executed on the PDA 1201 and appears on the touch screen 1204. The transducers 1205a-1205j also comprises a rechargeable battery, freeing the user from cumbersome power chords. Optionally the inertial sensors comprise accelerometers for detecting the relative motion between the knuckles. Alternatively the communication circuitry comprises wireless electromagnetic circuitry. Further alternatively the communication circuitry comprises fiber-less optoelectric circuitry. Optionally transducers are coupled to a knuckle or a finger wherein the inertial sensors detect relative motion between the fingers and or the knuckles. Further optionally, the inertial sensors are coupled elsewhere on the hand for providing sufficient inertial information for use in keystroke determination.

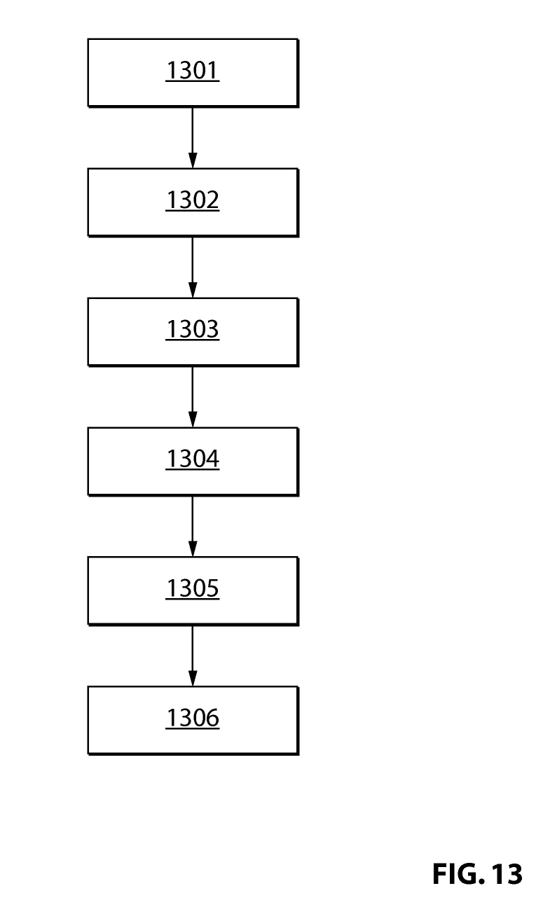

FIG. 13 illustrates the flow diagram of a user using transducers to interface with a PDA. The user installs software on the PDA to enable the smart phone to interface with the transducers 1301. The user attaches the transducers to his fingers and “pairs” the smart phone and the transducers 1302. When the devices are “paired” an indication appears on the screen of the PDA indicating that they are communicating via wireless electromagnetic or optoelectronic signals 1303. The user opens an application on the smart phone, for example SMS messaging 1304 and begins typing 1305. Information signals are transmitted from the transducers to the PDA 1305. Software executing on the smart phone processes the symbol entries and text appears on the screen 1306. Optionally the image of the user's fingers actuating the keys on the keyboard is on screen for the duration of the use of the transducers by the user. Further optionally the image of the user actuating the keys on the keyboard is on screen and disappears when the user is typing quickly and reappears when the user types slowly or pauses typing.

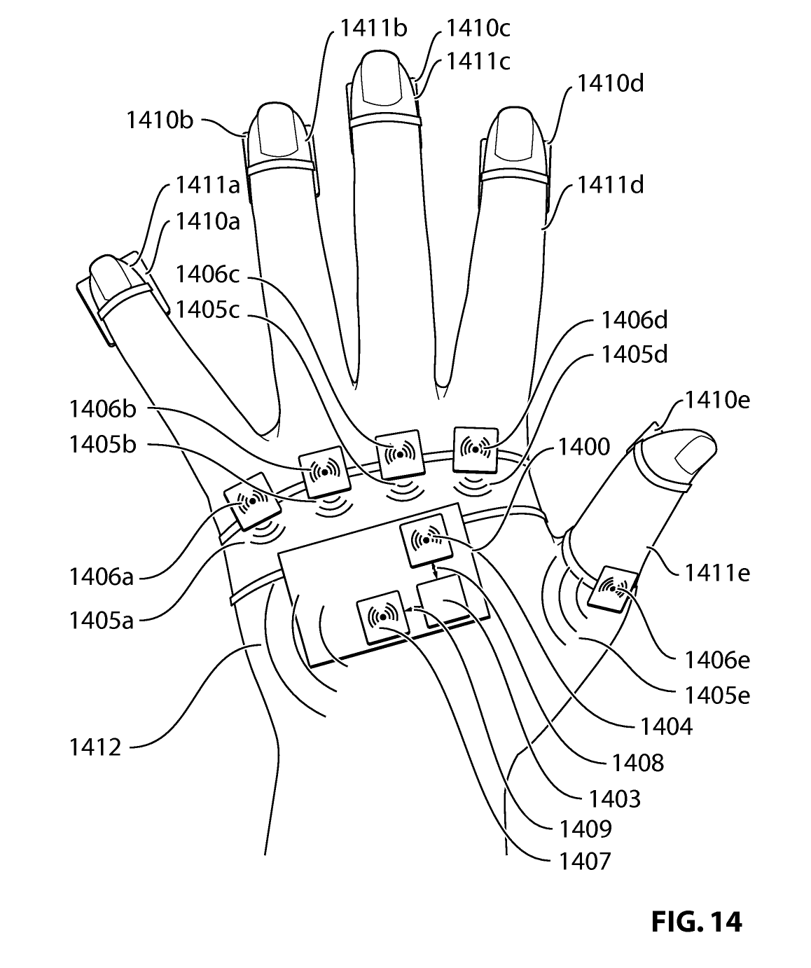

FIG. 14 illustrates an interface device 1400 coupled to a user's hand 1401, comprising a processor 1403 for executing API software and a first wireless communication circuit 1404, in the form of an infrared communication circuit, for receiving information signals 1405a-1405e, in the form of infrared wireless signals, and a second wireless communication circuit 1407, in the form of a Bluetooth™ communication circuit 1407 for transmitting Bluetooth™ signals to and receiving Bluetooth™ signals from a computer. The transducers 1406a-1406e are coupled to the user's fingers. As the user types, the infrared communication circuits of the transducers 1406a-1406e transmits infrared wireless information signals, representing symbol entries, to the infrared communication circuit 1404. The infrared communication circuit 1404 transmits first data indicative of the information signals received 1405a-1405e via data interface 1408 to the processor 1403. The processor 1409 executes API software, processes the first data, and transmits second data indicative of symbol entries via the data interface 1409 to the Bluetooth™ wireless communication circuit 1407. The API software formats the second data wherein the Bluetooth™ wireless signal 1408, transmitted from the Bluetooth™ communication circuit 1407, emulates the wireless interface from a known wireless peripheral, for example a wireless Bluetooth™ keyboard. Emulating a known wireless peripheral interface eliminates the need to install transducer-interfacing software on the computer thus increasing transducer compatibility with computers comprising known wireless peripheral communication interfaces. Alternatively the communication circuitry comprises wireless electromagnetic circuitry. Further alternatively the communication circuitry comprises fiber-less optoelectric circuitry. Optionally transducers are coupled to a knuckle or a finger wherein the inertial sensors detect relative motion between the fingers and or the knuckles. Further optionally, the inertial sensors are coupled elsewhere on the hand for providing sufficient inertial information for use in keystroke determination. According to an embodiment of the invention feedback transducers are coupled to the user's hand to provide tactile feedback when a user's virtual finger strikes a key on the virtual keyboard. Referring to FIG. 14 feedback transducers in the form of piezoelectric actuators 1410a-1410e, comprising wireless communication circuitry in the form of infrared receiver circuits, are attached to the finger pads of the user's fingers 1411a-1411e. When the user strikes a key on the virtual keyboard the processor 1409 receives feedback data from the computer via Bluetooth™ communication circuit 1407. The processor 1409 then transmits control data via the infrared communication circuit 1404 to the piezoelectric actuator that is coupled to the finger corresponding to the virtual finger that pressed the virtual key, resulting in the piezoelectric actuator device vibrating. For example finger 1411d actuates the virtual key representing the character “t” and piezoelectric actuator 1410d vibrates. The vibration motion indicates to the user that the finger has indeed pressed a key on the virtual keyboard and the tactile sensation provides a more comfortable experience than no tactile feedback at all. Alternatively the feedback transducers are coupled to processor via electrical cables. Alternatively the feedback transducers communicate with the computer. Optionally the feedback transducers are coupled to the user's hands. Alternatively the feedback transducers comprise a sensation-providing device. Alternatively the communication circuitry comprises wireless electromagnetic circuitry. Advantageously, by using common keyboard practices and mapping their movements onto keystrokes, a system results that is intuitive and easy to learn for providing very complex information—alphanumeric characters alone in English require 52 letters and 10 digits—with a simple and easily understood interface. Unlike many prior art attempts at providing symbol entry, little learning by a user experienced with a keyboard is necessary. In contrast, Graffiti® based handwriting recognition requires learning a new symbol for each and every character to be entered. In many cases, the learning curve for an interface such as that disclosed hereinabove is steeper than for a reduced size keyboard wherein characters are moved around to fit everything within the screen or physical layout of a device.

Though the term knuckles is used for mounting of the transducers thereon, the transducer is optionally mounted elsewhere such as on one or more fingers, on the palm, on the back of the hand, and so forth, selected for providing sufficient information for distinguishing between symbols.

Though inertial sensors are disclosed, optical sensors are also positionable on a hand of a user to measure relative motion between different portions of the hand in order to sense hand motions for use in determining a keystroke relating to a specific hand motion.

It will be understood by persons skilled in the art that though the above embodiments are described with reference to relative motion between fingers for indicating symbol entry, independent motion of at least one finger is also usable in many of the potential implementations either instead of relative motion or with appropriate overall modifications.

Numerous other embodiments of the invention will be apparent to persons skilled in the art without departing from the scope of the invention as defined in the appended claims.

1. A method comprising:
(a) providing a plurality of inertial sensors;
(b) coupling the inertial sensors to a plurality of fingers of a user;
(c) using the inertial sensors to detect relative motion between the fingers of the user;
(d) providing a signal including first data relating to the relative motion to a first processor, the first processor for determining a unique symbol in response to the motion, the first symbol indicative of a key virtually struck by a keystroke motion of the fingers of the user.

2. A method according to claim 1 wherein the first processor further emulates a keyboard and generates provides the first symbol.

3. (canceled)

4. A method according to claim 1 comprising:
displaying on a display a virtual representation of a determined location of at least one of the fingers of the user relative to a displayed image of a keyboard including the key.

5. A method according to claim 1 wherein the inertial sensors are coupled to top of the fingers of the user.

6. A method according to claim 1 comprising: training the first processor to based on training data for use in correlating relative motion to unique keystrokes.

7. A method comprising:
(a) providing an inertial sensor;
(b) coupling the inertial sensor to a hand of a user;
(c) using the inertial sensor to detect motion of the hand;
(d) using a first processor and based on the motion, determining a symbol entry, wherein the symbol is a unique output in response to the motion; and
(e) providing, to a keyboard emulator, symbol information corresponding character on a known keyboard.

8. (canceled)

9. (canceled)

10. A method according to claim 7 comprising:
displaying on a display a virtual representation of a determined location of at least one virtual finger of the hand of the user relative to an image of a keyboard.

11. A method according to claim 7 wherein the inertial sensor is coupled to back of the hand of the user.

12. A method according to claim 7 comprising:
training the first processor based on training correlation data for use in correlating motion of the hand to unique keystrokes.

13. A method according to claim 7 wherein the inertial sensor is mounted to a finger of the hand of the user.

14. A method according to claim 7 wherein the motion comprises relative motion between different portions of the hand of the user.

15. A method according to claim 7 comprising:
(a) providing a second inertial sensor;
(b) coupling the second inertial sensor to hands of a user, wherein the symbol is determined based on data from both the inertial sensor and the second inertial sensor.

16. A method comprising:
(a) providing an inertial sensor;
(b) coupling the inertial sensor to a body part of a user;
(c) using the inertial sensor to detect motion of the body part;
(d) based on the motion, determining a symbol entry, wherein the symbol is a unique output value in response to the motion; and
(e) providing the symbol to a computer.

17. A method according to claim 16 wherein the motion comprises relative motion between different portions of the hand.

18. A method according to claim 16 comprising:
(a) providing a second inertial sensor;
(b) coupling the second inertial sensor to hands of a user, wherein the symbol is determined based on data from both the inertial sensor and the second inertial sensor.

19. A method according to claim 1 comprising:
(a) providing a feedback transducer comprising a sensation-providing device;
(b) coupling the feedback transducer to a first finger of the plurality of fingers of the user;
(c) transmitting control data to the feedback transducer when the first finger corresponds to a virtual finger that presses a virtual key on a virtual keyboard; and
(d) activating the feedback transducer.

20. A method according to claim 7 comprising:
(a) providing a feedback transducer comprising a sensation-providing device;
(b) coupling the feedback transducer to the hand of the user;
(c) transmitting control data to the feedback transducer when a finger of the hand of the user corresponds to a virtual finger that presses a virtual key on a virtual keyboard; and
(d) activating the feedback transducer.

21. A method according to claim 1 wherein providing the plurality of inertial sensors comprises providing a plurality of accelerometers.

22. A method according to claim 21 wherein providing the plurality of inertial sensors further comprises providing a plurality of gyroscopes.

23. A method according to claim 1 wherein providing the plurality of inertial sensors comprises providing a plurality of gyroscopes.

24. A method according to claim 10 wherein providing the inertial sensor comprises providing an accelerometer.

25. A method according to claim 24 wherein providing the inertial sensor further comprises providing a gyroscope.

26. A method according to claim 10 wherein providing the inertial sensor comprises providing a gyroscope.

27. A method according to claim 16 wherein providing the inertial sensor comprises providing an accelerometer.

28. A method according to claim 27 wherein providing the inertial sensor further comprises providing a gyroscope.

29. A method according to claim 16 wherein providing the inertial sensor comprises providing a gyroscope.

30. A method according to claim 18 wherein the inertial sensor and the second inertial sensor are coupled to a same finger of the hand of the user.
